(19) United States
(12) Patent Application Publication
(10) Pub. No.: US 2026/0162462 A1
(43) Pub. Date: Jun. 11, 2026

(54) TASK ANALYSIS DEVICE

(71) Applicant: FANUC CORPORATION, Yamanashi (JP)

(72) Inventors: Tomofumi UWANO, Yamanashi (JP); Kazuhiro YAMATO, Yamanashi (JP)

(73) Assignee: FANUC CORPORATION, Yamanashi (JP)

(21) Appl. No.: 18/706,209

(22) PCT Filed: Dec. 9, 2021
(86) PCT No.: PCT/JP2021/045391

§ 371 Date: Apr. 30, 2024

(51) Int. Cl. G06V 40/20; G06T 7/246; G06T 7/70; G06V 10/764; G06V 20/40

(52) U.S. Cl. CPC G06V 40/28; G06T 7/246; G06T 7/70; G06V 10/764; G06V 20/46; G06T 2207/10016; G06T 2207/30196

(57) ABSTRACT

The present invention recognizes an object from an image to classify work with a small computation amount. Provided is a work analysis device for analyzing work of a worker, the work analysis device comprising: a joint position estimation unit that estimates joint position information relating to the worker from video data including the work of the worker; a motion estimation unit that estimates motion information relating to the worker on the basis of the joint position information estimated by the joint position estimation unit; an image extraction unit that extracts a range of the video data relating to an object relevant to the motion information from the video data on the basis of the motion information estimated by the motion estimation unit; an object recognition unit that recognizes the object in the range of the video data extracted by the image extraction unit; and a work identification unit that identifies the work of the worker on the basis of the object recognized by the object recognition unit.

### TECHNICAL FIELD

The present invention relates to a task analysis device.

### BACKGROUND ART

In factories, operation data pertaining to, for example, machine tools can be acquired, but data on the tasks of workers cannot be acquired. Improving tasks, examining whether to introduce a robot, and implementing, for example, a digital twin of a factory involve visualizing the tasks of workers, and the technique of automatically recognizing what was being performed from video of a worker's task is important.

In this regard, a technique is known in which: machine learning is performed using training data that is formed from input data pertaining to images provided by imaging the tasks of workers and label data pertaining to the tasks of the workers indicated by the images; a trained model for identifying a task from an image is generated; and, by using the trained model, it is identified what task is being performed in an image to be analyzed. Reference should be made to, for example, Patent Document 1.

A technique is also known in which: the position of the hand of a worker is identified from depth-imparted image data captured by a depth sensor; and the position of an object is identified from image data captured using a digital camera in order to identify details of a motion that was made by the worker in a task. Reference should be made to, for example, Patent Document 2.

### CITATION LIST

### Patent Document

Patent Document 1: Japanese Unexamined Patent Application, Publication No. 2021-67981

Patent Document 2: PCT International Publication No. WO2017/222070

### DISCLOSURE OF THE INVENTION

### Problems to be Solved by the Invention

However, classification models such as the trained model in Patent Document 1 have the problems of complexity and low interpretability.

Meanwhile, detecting a used tool (object) from an image for task classification as in Patent Document 2 requires a large computation amount to scan the entirety of the image.

Accordingly, it is desirable to recognize an object from an image so as to classify a task with a small computation amount.

### Means for Solving the Problems

One aspect of a task analysis device of the present disclosure is a task analysis device for analyzing a task of a worker, the task analysis device including: a joint-position estimation unit configured to estimate joint position information pertaining to the worker from video data including the task of the worker; a motion estimation unit configured to estimate motion information pertaining to the worker on the basis of the joint position information estimated by the joint-position estimation unit; an image extraction unit configured to extract, from the video data on the basis of the motion information estimated by the motion estimation unit, a range on the video data that pertains to an object associated with the motion information; an object recognition unit configured to recognize the object within the range on the video data that has been extracted by the image extraction unit; and a task identification unit configured to identify the task of the worker on the basis of the object recognized by the object recognition unit.

One aspect of the task analysis device of the present disclosure is a task analysis device for analyzing a task of a worker, the task analysis device including: an object detection unit configured to detect an object from video data including the task of the worker; a joint-position estimation unit configured to estimate joint position information pertaining to the worker from the video data; an object region entry/exit sensing unit configured to sense, on the basis of the joint position information estimated by the joint-position estimation unit, whether an image region including a joint position of the worker has entered and then exited from an image region including the object detected by the object detection unit; an image extraction unit configured to extract, from the video data, a range on the video data that pertains to the object detected by the object detection unit on the basis of the result of sensing by the object region entry/exit sensing unit; an object recognition unit configured to perform object recognition for the range on the video data that has been extracted by the image extraction unit; an object-detection activation unit configured to cause the object detection unit to periodically detect the object in a case where the object recognition unit is unable to recognize the object within the range on the video data; and a task estimation unit configured to identify the task on the basis of a change in a coordinate of the object detected in the video data by the object detection unit.

### Effects of the Invention

One aspect allows an object to be recognized from an image so as to classify a task with a small computation amount.

### BRIEF DESCRIPTION OF THE DRAWINGS

FIG. 1 is a functional block diagram illustrating a functional configuration example of a task analysis system according to a first embodiment;

FIG. 2A illustrates an example of ranges on video data, the ranges corresponding to a tool (object) and motion information pertaining to a worker;

FIG. 2B illustrates an example of ranges on video data, the ranges corresponding to a tool (object) and motion information pertaining to a worker;

FIG. 3 illustrates an example of a task table;

FIG. 4A illustrates an example of a shape assumed by a hand holding a screwdriver;

FIG. 4B illustrates an example of a shape assumed by a hand holding a caliper, the shape being similar to the shape in FIG. 4A;

FIG. 5A illustrates, with reference to the video data depicted in FIG. 2B, an example of video data extracted when the shape assumed by the worker's hand is a shape assumed when a screwdriver is used;

FIG. 5B illustrates, with reference to the video data depicted in FIG. 2B, an example of video data extracted when the shape assumed by the worker's hand is a shape assumed when a screwdriver is used;

FIG. 6 is a flowchart illustrating analysis processing performed by the task analysis device;

FIG. 7 is a functional block diagram illustrating a functional configuration example of a task analysis system according to a second embodiment;

FIG. 8 illustrates an example of video data including a task of a worker;

FIG. 9 illustrates an example of video data including a task of a worker;

FIG. 10 illustrates an example of video data including a task of a worker;

FIG. 11 illustrates an example of video data including a task of a worker; and

FIG. 12 is a flowchart illustrating analysis processing performed by the task analysis device.

### PREFERRED MODE FOR CARRYING OUT THE INVENTION

The following describes first and second embodiments of the task analysis device in detail with reference to the drawings.

The embodiments share the common feature of identifying a task of a worker from an image of the worker and an object (tool) captured using a camera.

In the identifying of the task of the worker, however, the first embodiment involves: estimating joint position information pertaining to the worker from video data including the task of the worker; estimating motion information pertaining to the worker on the basis of the estimated joint position information pertaining to the worker; extracting, from the video data on the basis of the estimated motion information pertaining to the worker, a range on the video data that pertains to an object associated with the motion information; recognizing the object from the extracted range on the video data; and identifying the task of the worker from the recognized object. The second embodiment differs from the first embodiment in that the same involves: detecting an object from video data including the task of the worker, and estimating joint position information pertaining to the worker from the video data; sensing, on the basis of the estimated joint position information pertaining to the worker, whether an image region including a joint position of the worker has entered and then exited from an image region including the detected object; extracting, from the video data on the basis of the result of sensing, a range on the video data that pertains to the object detected from the video data; performing object recognition for the extracted range on the video data; and periodically detecting the object when the object cannot be recognized within the range on the video data, so as to determine the task of the worker on the basis of a change in a coordinate of the object.

In the following, the first embodiment is described in detail first, and then the second embodiment is described by focusing mainly on different features from the first embodiment.

### FIRST EMBODIMENT

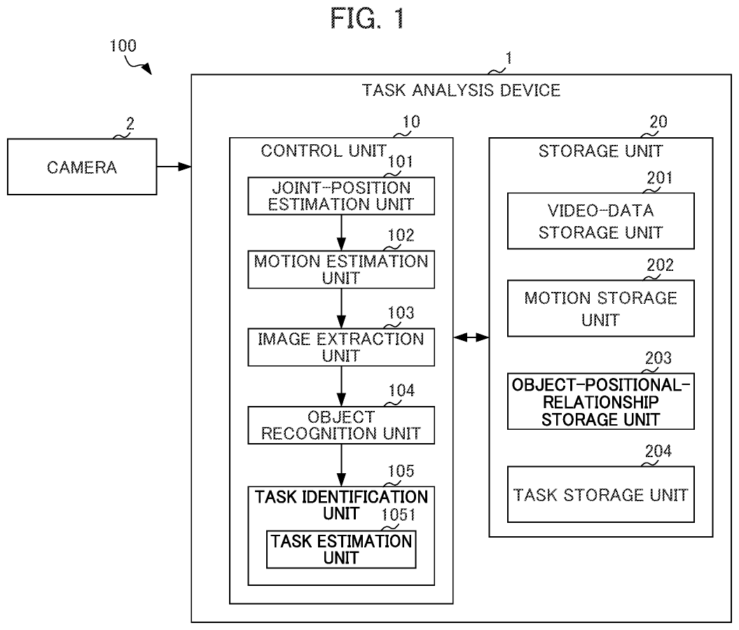

FIG. 1 is a functional block diagram illustrating a functional configuration example of a task analysis system according to the first embodiment.

As depicted in FIG. 1, the task analysis system 100 includes a task analysis device 1 and a camera 2.

The task analysis device 1 and the camera 2 may be connected to each other over a network (not shown) such as a local area network (LAN) or the Internet. In this case, the task analysis device 1 and the camera 2 are provided with a communication unit (not shown) for allowing these two to communicate with each other using such a connection. In the meantime, the task analysis device 1 and the camera 2 may be directly connected to each other via a connection interface (not shown) wirelessly or by a wired link.

Although, in FIG. 1, the task analysis device 1 is connected to one camera 2, the task analysis device 1 may be connected to two or more, i.e., a plurality of, cameras 2.

The camera 2, which is, for example, a digital camera, captures, at a prescribed frame rate (e.g., 30 fps), two-dimensional frame images by projecting a worker and an object such as a tool (neither of which are shown) onto a plane perpendicular to the optical axis of the camera 2. The camera 2 outputs the captured frame images to the task analysis device 1 as video data. The video data captured using the camera 2 may be RGB color images, gray scale images, or visible light images such as depth images.

### Task Analysis Device 1

The task analysis device 1, which is a computer publicly known to those skilled in the art, includes, as depicted in FIG. 1, a control unit 10 and a storage unit 20. The control unit 10 includes a joint-position estimation unit 101, a motion estimation unit 102, an image extraction unit 103, an object recognition unit 104, and a task identification unit 105. The task identification unit 105 includes a task estimation unit 1051.

The storage unit 20 is a storage device such as a read only memory (ROM) or a hard disk drive (HDD). The storage unit 20 stores, for example, an operating system and an application program executed by the control unit 10 (described hereinafter). The storage unit 20 includes a video-data storage unit 201, a motion storage unit 202, an object-positional-relationship storage unit 203, and a task storage unit 204.

The video-data storage unit 201 stores video data pertaining to a worker and an object such as a tool that has been captured using the camera 2.

The motion storage unit 202 stores a rule base or a trained model that outputs motion information pertaining to the worker, the motion information being estimated by the motion estimation unit 102 (described hereinafter) and corresponding to joint position information pertaining to the worker. Specifically, for example, the motion storage unit 202 may store a trained model such as a neural network generated in advance by publicly known machine learning in which: input data is constituted by joint position information including joint positions of, for example, the hands of workers in video data pertaining to these workers, the workers performing tasks (e.g., “MEASUREMENT WITH CALIPER,” “TIGHTENING SCREW”) that have been imaged using the camera 2 and are required to be identified; and training data with the tasks as label data is used. Alternatively, the motion storage unit 202 may store a rule base in which joint position information pertaining to workers in video data pertaining to these workers, who are performing tasks that have been imaged using the camera 2 and are required to be identified, is associated with the tasks on the basis of a publicly known technique.

On the basis of motion information pertaining to the worker that is estimated by the motion estimation unit 102 (described hereinafter), the object-positional-relationship storage unit 203 stores, in advance, a range on video data, the range including a tool (object) associated with the motion information.

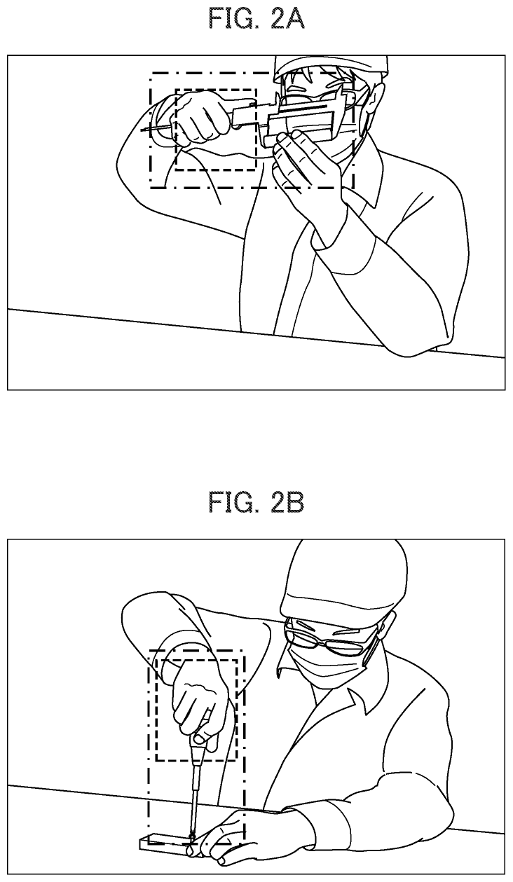

FIGS. 2A and 2B each illustrate an example of ranges on video data, the ranges corresponding to a tool (object) and motion information pertaining to a worker. FIG. 2A depicts an image corresponding to motion information obtained when the worker performs measurement with a caliper. FIG. 2B depicts an image corresponding to motion information obtained when the worker tightens a screw with a screwdriver.

When the worker performs measurement with a caliper as depicted in FIG. 2A, the object-positional-relationship storage unit 203 stores, in advance as a range on the video data in which the caliper (object) is present, relative position coordinates in, for example, a rectangular image coordinate system that is indicated by a dashed dotted line and is long in the horizontal direction with reference to a joint position (rectangle indicated by a broken line) of the hand of the worker, the joint position being indicated by joint position information estimated by the joint-position estimation unit 101 (described hereinafter).

When the worker tightens a screw as depicted in FIG. 2B, the object-positional-relationship storage unit 203 stores, in advance as a range on the video data in which the screwdriver (object) is present, relative position coordinates in, for example, a rectangular image coordinate system that is indicated by a dashed dotted line and is long in the vertical direction with reference to a joint position (rectangle indicated by a broken line) of the hand of the worker, the joint position being indicated by joint position information estimated by the joint-position estimation unit 101 (described hereinafter).

The task storage unit 204 stores a task table in which a tool (object) recognized by the object recognition unit 104 (described hereinafter) is associated with a corresponding task of a worker.

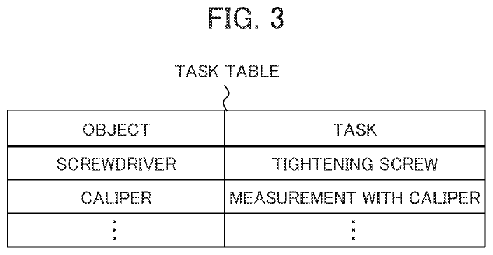

FIG. 3 illustrates an example of the task table.

As indicated in FIG. 3, the task table includes storage regions of “OBJECT” and “TASK.”

For example, the storage regions of “OBJECT” in the task table have tool names such as “screwdriver” and “caliper” stored therein.

For example, the storage regions of “TASK” in the task table have tasks such as “TIGHTENING SCREW” and “MEASUREMENT WITH CALIPER” stored therein.

Information may be registered in the storage regions of “OBJECT” and “TASK” in the task table in advance by a user such as a worker using an input device such as a keyboard or a touch panel included in the task analysis device 1.

The control unit 10 includes, for example, a CPU, a ROM, a random access memory (RAM), and a CMOS memory, which are publicly known to those skilled in the art and configured to be capable of communicating with each other via a bus.

The CPU is a processor that controls the entirety of the task analysis device 1. The CPU reads, via the bus, a system program and an application program stored in the ROM, and controls the entirety of the task analysis device 1 in accordance with the system program and the application program. Thus, as indicated in FIG. 1, the control unit 10 is configured to implement the functions of the joint-position estimation unit 101, the motion estimation unit 102, the image extraction unit 103, the object recognition unit 104, and the task identification unit 105. The task identification unit 105 is configured to implement the function of the task estimation unit 1051. The RAM stores various types of data such as temporary computational data and display data. The CMOS memory is formed as a nonvolatile memory backed up by a battery (not shown), and the storage status thereof is maintained even when the task analysis device 1 is turned off.

The joint-position estimation unit 101 estimates joint position information pertaining to a worker from video data including a task of the worker.

Specifically, by using a publicly known technique (e.g., SUGANO, Kosuke, OKU, Kenta, KAWAGOE, Kyoji, “Motion Detection from Multidimensional Time-Series Data, and Classification Method,” DEIM Forum 2016 G4-5, or UEZONO, Shohei, ONO, Satoshi, “Feature extraction using LSTM Autoencoder for multimodal sequential data,” Materials for Conference of the Japanese Society for Artificial Intelligence, SIG-KBS-B802-01, 2018), the joint-position estimation unit 101 estimates, as joint position information, time-series data pertaining to the coordinates and the angle (shape assumed by the hand) of a joint of, for example, the hand of the worker from the video data stored by the video-data storage unit 201, with time information having been added to the video data.

The following descriptions are given with reference to a situation in which the joint-position estimation unit 101 estimates a joint position of the hand of a worker as joint position information. However, the joint-position estimation unit 101 may estimate a joint position of a site of the worker other than the hand in the same manner as the joint position of the hand.

The motion estimation unit 102 estimates motion information pertaining to the worker on the basis of the joint position information estimated by the joint-position estimation unit 101.

Note that the following describes a situation in which the motion estimation unit 102 estimates motion information specific to “MEASUREMENT WITH CALIPER” in FIG. 2A and “TIGHTENING SCREW” in FIG. 2B as motions of the worker.

However, the motion estimation unit 102 estimates motion information specific to motions other than “MEASUREMENT WITH CALIPER” and “TIGHTENING SCREW” in the same manner as “MEASUREMENT WITH CALIPER” and “TIGHTENING SCREW.”

Specifically, for example, the motion estimation unit 102 inputs, to the trained model stored by the motion storage unit 202 as input data, the joint position information estimated by the joint-position estimation unit 101 and indicating the shape assumed by the hand, and estimates the motion (i.e., “MEASUREMENT WITH CALIPER” or “TIGHTENING SCREW) of the worker in the video data. Alternatively, the motion estimation unit 102 may estimate the motion of the worker in the video data on the basis of the rule base stored by the motion storage unit 202 and the joint position information estimated by the joint-position estimation unit 101 and indicating the shape assumed by the hand. In addition to the estimated motion information pertaining to the worker, the motion estimation unit 102 may calculate, for example, a likelihood indicative of the probability of the shape (joint position of the hand) assumed by the hand making the motion indicated by the motion information.

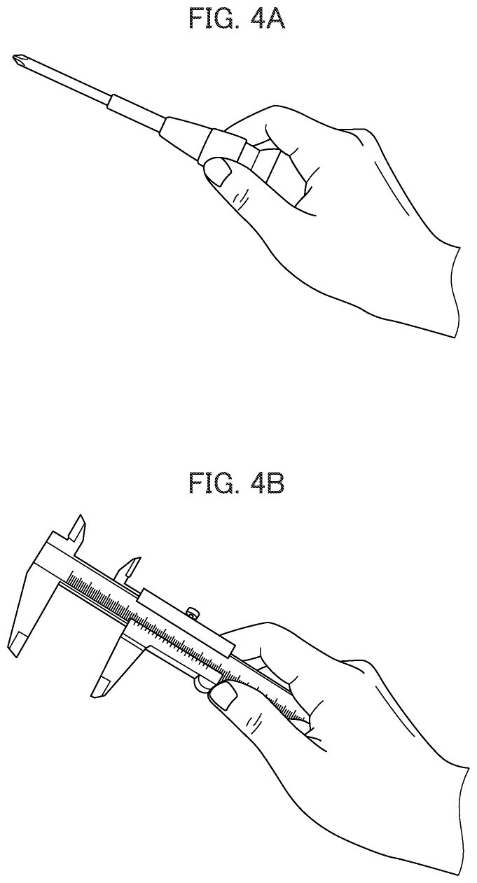

When the shape assumed by the hand that has been estimated by the joint-position estimation unit 101 is ambiguous as depicted in FIGS. 4A and 4B and thus corresponds to two or more similar joint positions that are each achieved when a different object (tool) is held, the motion estimation unit 102 may estimate a plurality of motions as motion information. FIG. 4A illustrates an example of a shape assumed by a hand holding a screwdriver. FIG. 4B illustrates an example of a shape assumed by a hand holding a caliper, the shape being similar to the shape in FIG. 4A.

On the basis of motion information estimated by the motion estimation unit 102, the image extraction unit 103 extracts, from video data, a range on the video data that pertains to an object (tool) associated with the motion information.

Specifically, for example, the image extraction unit 103 obtains, from the object-positional-relationship storage unit 203, relative position coordinates in the image coordinate system, the relative position coordinates being the range that is to be extracted on the video data and corresponds to the motion information estimated by the motion estimation unit 102. As indicated in FIGS. 2A and 2B, the image extraction unit 103 extracts video data in a rectangular range indicated by a dashed dotted line on the basis of the relative position coordinates, which are obtained with reference to the joint position (rectangle indicated by a broken line) of the hand of the worker.

When motion information estimated by the motion estimation unit 102 includes a plurality of motions, the image extraction unit 103 obtains, in the image coordinate system, relative position coordinates corresponding to the individual motions indicated by the motion information, and extracts the video data in a rectangular range on the basis of the relative position coordinates that have been obtained with reference to the joint position of the hand of the worker and correspond to the individual motions.

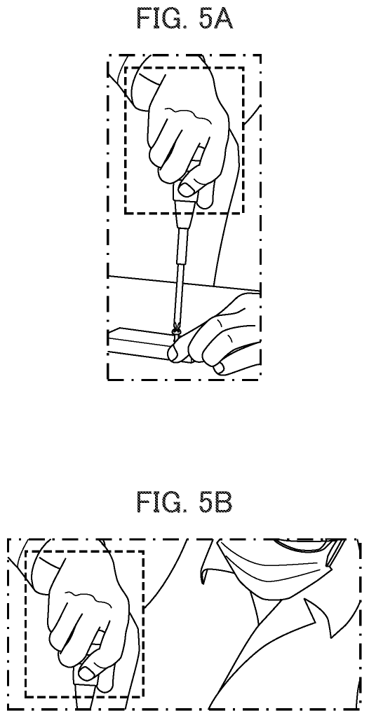

FIGS. 5A and 5B illustrate an example of video data extracted when motion information includes a plurality of motions.

FIG. 5A illustrates, with reference to the video data depicted in FIG. 2B, an example of video data extracted when the shape assumed by the worker's hand is a shape assumed when a screwdriver is used. FIG. 5B illustrates, with reference to the video data depicted in FIG. 2B, an example of video data extracted when the shape assumed by the worker's hand is a shape assumed when a caliper is used.

The object recognition unit 104 recognizes an object (tool) within the range on video data that has been extracted by the image extraction unit 103.

Specifically, for example, the object recognition unit 104 extracts an image feature amount such as an edge amount for the extracted video data by using a publicly known technique. The object recognition unit 104 performs a process of matching between the extracted image feature amount and image feature amounts stored in the storage unit 20 in advance for individual tools (objects), so as to recognize the tool (object) in the extracted video data. The object recognition unit 104 may also calculate a likelihood indicative of the probability of the recognized tool (object).

For example, when the motion information estimated by the motion estimation unit 102 includes a plurality of motions, the object recognition unit 104 may recognize a screwdriver (object) from the extracted range of the video data in FIG. 5A and determine that the likelihood of a screwdriver is 90%. Meanwhile, as a caliper (tool) cannot be recognized from the extracted range of the video data in FIG. 5B, the object recognition unit 104 may determine that the likelihood of a caliper (object) is 3%.

The task identification unit 105 identifies the task of the worker on the basis of the object (tool) recognized by the object recognition unit 104.

Specifically, the task identification unit 105 identifies the task of the worker on the basis of, for example, the tool (object) recognized by the object recognition unit 104 and the task table stored by the task storage unit 204. The task identification unit 105 may display the identified task on a display device (not shown) such as a liquid crystal display included in the task analysis device 1.

If a tool (object) recognized by the object recognition unit 104 is not registered in the task table stored by the task storage unit 204, the task identification unit 105 may display a message, e.g., “task unidentifiable,” on the display device (not shown) of the task analysis device 1.

When motion information estimated by the motion estimation unit 102 includes a plurality of motions, the task estimation unit 1051 estimates a task having the highest likelihood on the basis of the likelihoods of shapes (joint positions of the hand) each assumed by the hand making an individual motion from among the plurality of motions estimated by the motion estimation unit 102 and the likelihoods of objects recognized for a plurality of ranges on video data that have been extracted by the object recognition unit 104.

With respect to the video data depicted in FIG. 5A, for example, if the likelihood of the shape (joint position of the hand) assumed by the hand making the motion of “TIGHTENING SCREW” estimated by the motion estimation unit 102 is 60% and the likelihood of a “SCREWDRIVER” recognized by the object recognition unit 104 is 90%, the task estimation unit 1051 determines that the likelihood of the task of “TIGHTENING SCREW” is 0.5(=0.6×0.9 ). With respect to the video data depicted in FIG. 5B, if the likelihood of the shape (joint position of the hand) assumed by the hand making the motion of “MEASUREMENT WITH CALIPER” estimated by the motion estimation unit 102 is 40% and the likelihood of a “CALIPER” recognized by the object recognition unit 104 is 3%, the task estimation unit 1051 determines that the likelihood of the task of “MEASUREMENT WITH CALIPER” is 0.01(=0.4×0.03 ). Then, the task estimation unit 1051 specifies the “TIGHTENING SCREW,” which has the highest likelihood of 0.5, as the task of the worker.

### <Analysis Processing Performed By Task Analysis Device 1>

Next, descriptions are given of operations pertaining to the analysis processing performed by the task analysis device 1 according to the first embodiment.

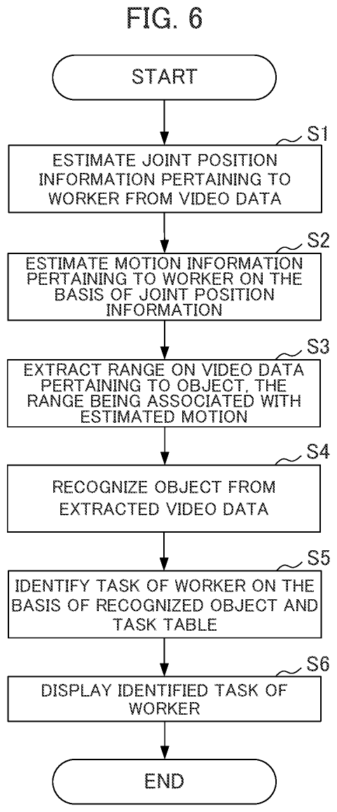

FIG. 6 is a flowchart illustrating the analysis processing performed by the task analysis device 1. The indicated flow is performed repeatedly while video data is input from the camera 2.

In Step S1, the joint-position estimation unit 101 estimates joint position information pertaining to the hand of a worker from video data including the task of the worker.

In Step S2, the motion estimation unit 102 estimates motion information pertaining to the worker on the basis of the joint position information estimated in Step S1.

In Step S3, the image extraction unit 103 extracts a range on the video data that pertains to an object (tool) associated with a motion included in the motion information estimated in Step S2. When motion information estimated in Step S2 includes a plurality of motions, the image extraction unit 103 extracts, for each of the motions, a range on the video data that pertains to an associated object (tool).

In Step S4, the object recognition unit 104 recognizes an object (tool) within the range on the video data that has been extracted in Step S3. When a plurality of pieces of video data are extracted in Step S3, the object recognition unit 104 recognizes an object (tool) within a range on each of the plurality of pieces of video data.

In Step S5, the task identification unit 105 identifies the task of the worker on the basis of the tool (object) recognized in Step S4 and the task table stored by the task storage unit 204. When the motion estimation unit 102 has estimated a plurality of motions in Step S2, the task estimation unit 1051 identifies a task having the highest likelihood as the task of the worker on the basis of the likelihoods of shapes (joint positions of the hand) each assumed by the hand making an individual motion from among the plurality of motions estimated in Step S2 and the likelihoods of objects recognized in Step S4 for the plurality of pieces of video data extracted in Step S3.

In Step S6, the task identification unit 105 displays the task identified in Step S5 on the display device (not shown) of the task analysis device 1. If the tool (object) recognized in Step S4 is not registered in the task table stored by the task storage unit 204, the task identification unit 105 displays a message, e.g., “task unidentifiable,” on the display device (not shown) of the task analysis device 1.

As described above, the task analysis device 1 according to the first embodiment estimates joint position information pertaining to the worker from video data including the task of the worker, estimates motion information pertaining to the worker on the basis of the estimated joint position information pertaining to the worker, extracts, from the video data on the basis of the estimated motion information pertaining to the worker, a range on the video data that pertains to an object associated with the motion information, recognizes the object from the extracted range on the video data, and identifies the task of the worker from the recognized object. Thus, the task analysis device 1 can recognize an object from an image so as to classify a task with a small computation amount.

The task analysis device 1 can also be implemented using an inexpensive device without the need for, for example, an expensive GPU.

The task analysis device 1 easily interprets the model of task classification, and the user can be convinced to use the same. For example, if there are problems with the accuracy in task classification, the problems can be divided into those whether the accuracy in object recognition is low and those whether the accuracy in detection of a characteristic joint position of a hand is low, so that the classification model can be easily extended and improved.

So far, descriptions have been given of the first embodiment.

The following describes the second embodiment. The first embodiment involves: estimating joint position information pertaining to the worker from video data including the task of a worker; estimating motion information pertaining to the worker on the basis of the estimated joint position information pertaining to the worker; extracting, from the video data on the basis of the estimated motion information pertaining to the worker, a range on the video data that pertains to an object associated with the motion information; recognizing the object from the extracted range on the video data; and identifying the task of the worker from the recognized object. The second embodiment differs from the first embodiment in that the same involves: detecting an object from video data including the task of a worker, and estimating joint position information pertaining to the worker from the video data; sensing, on the basis of the estimated joint position information pertaining to the worker, whether an image region including a joint position of the worker has entered and then exited from an image region including the detected object; extracting, from the video data on the basis of the result of sensing, a range on the video data that pertains to the object detected from the video data; performing object recognition for the extracted range on the video data; and periodically detecting the object when the object cannot be recognized within the range on the video data, so as to determine the task of the worker on the basis of a change in a coordinate of the object.

Thus, the task analysis device 1A according to the second embodiment can recognize an object from an image so as to classify a task with a small computation amount.

In the following, descriptions are given of the second embodiment.

### SECOND EMBODIMENT

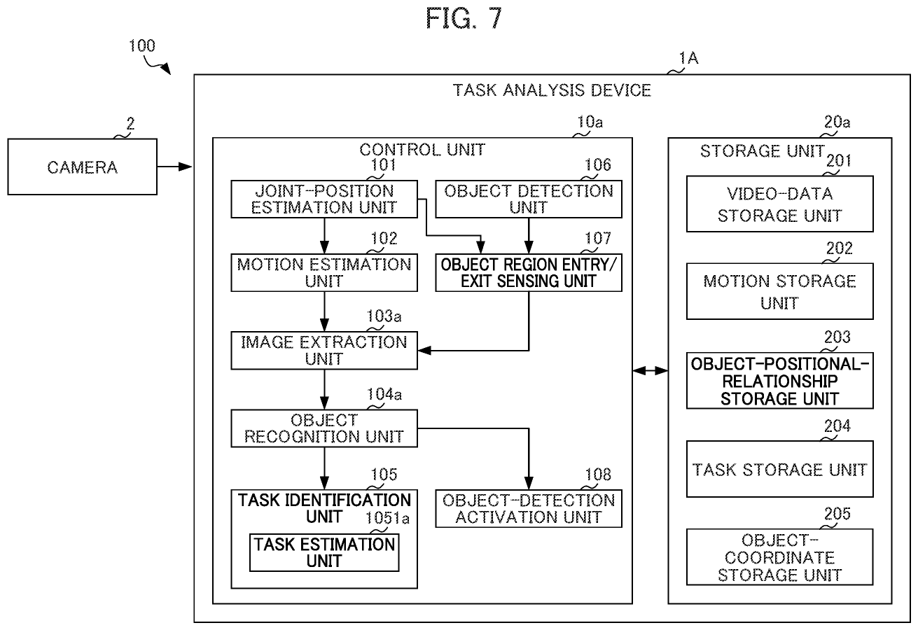

FIG. 7 is a functional block diagram illustrating a functional configuration example of a task analysis system according to the second embodiment. Like elements that have similar functions to the elements of the task analysis system 100 in FIG. 1 are indicated by like reference marks, and detailed descriptions thereof are omitted herein.

As depicted in FIG. 7, the task analysis system 100 includes a task analysis device 1A and a camera 2.

The camera 2 has equivalent functions to the camera 2 in the first embodiment.

### <Task Analysis Device 1A>

As depicted in FIG. 7, the task analysis device 1A includes a control unit 10a and a storage unit 20a. The control unit 10a includes a joint-position estimation unit 101, a motion estimation unit 102, an image extraction unit 103a, an object recognition unit 104a, a task identification unit 105, an object detection unit 106, an object region entry/exit sensing unit 107, and an object-detection activation unit 108. The task identification unit 105 includes a task estimation unit 1051a.

The storage unit 20a is a storage device such as a ROM or a HDD. The storage unit 20a stores, for example, an operating system and an application program executed by the control unit 10a (described hereinafter). The storage unit 20a includes a video-data storage unit 201, a motion storage unit 202, an object-positional-relationship storage unit 203, a task storage unit 204, and an object-coordinate storage unit 205.

The video-data storage unit 201, the motion storage unit 202, the object-positional-relationship storage unit 203, and the task storage unit 204 store equivalent data to the video-data storage unit 201, the motion storage unit 202, the object-positional-relationship storage unit 203, and the task storage unit 204 in the first embodiment.

The object-coordinate storage unit 205 stores the coordinates of a tool (object) in an image coordinate system, the tool (object) being detected from video data by the object detection unit 106 (described hereinafter).

The control unit 10a includes, for example, a CPU, a ROM, a RAM, and a CMOS memory, which are publicly known to those skilled in the art and configured to be capable of communicating with each other via a bus.

The CPU is a processor that controls the entirety of the task analysis device 1A. The CPU reads, via the bus, a system program and an application program stored in the ROM, and controls the entirety of the task analysis device 1A in accordance with the system program and the application program. In this way, as indicated in FIG. 7, the control unit 10a is configured to implement the functions of the joint-position estimation unit 101, the motion estimation unit 102, the image extraction unit 103a, the object recognition unit 104a, the task identification unit 105, the object detection unit 106, the object region entry/exit sensing unit 107, and the object-detection activation unit 108. The task identification unit 105 is configured to implement the function of the task estimation unit 1051a.

The joint-position estimation unit 101, the motion estimation unit 102, and the task identification unit 105 have equivalent functions to the joint-position estimation unit 101, the motion estimation unit 102, and the task identification unit 105 in the first embodiment.

As with the image extraction unit 103 in the first embodiment, on the basis of the motion information estimated by the motion estimation unit 102, the image extraction unit 103a extracts, from the video data, a range on the video data that pertains to the object (tool) associated with the motion information. Meanwhile, on the basis of a result of sensing by the object region entry/exit sensing unit 107 (described hereinafter), the image extraction unit 103a extracts, from the video data, the range on the video data that pertains to the object (tool) detected by the object detection unit 106 (described hereinafter).

As with the object recognition unit 104 in the first embodiment, the object recognition unit 104a recognizes an object (tool) within the range on video data that has been extracted by the image extraction unit 103a. Meanwhile, on the basis of the result of sensing by the object region entry/exit sensing unit 107 (described hereinafter), the object recognition unit 104a recognizes an object (tool) within the range on video data that has been extracted by the image extraction unit 103a.

The task estimation unit 1051a identifies a task on the basis of a change in the coordinates of a tool (object) detected by the object detection unit 106 (described hereinafter). Note that operations of the task estimation unit 1051a are described hereinafter.

The object detection unit 106 detects a tool (object) from video data including the task of a worker.

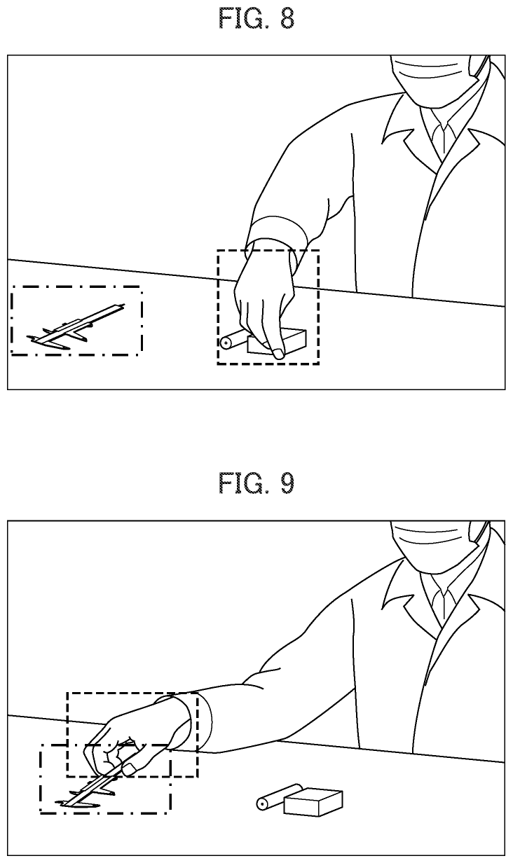

FIG. 8 illustrates an example of video data including the task of a worker.

In the video data depicted in FIG. 8, a caliper is placed on the table but is not used by the worker. By using a publicly known technique, the object detection unit 106 extracts an image feature amount such as an edge amount for the entirety of the image of video data depicted in FIG. 8.

The object detection unit 106 performs a process of matching between the extracted image feature amount and image feature amounts stored in the storage unit 20 in advance for individual tools (objects), so as to detect the tool (object) in the video data, and obtains, in the image coordinate system, the coordinates of an image region (rectangle indicated by a dashed dotted line) including the detected tool (object). The object detection unit 106 stores, in the object-coordinate storage unit 205, the obtained coordinates of the image region (rectangle indicated by a dashed dotted line) in the image coordinate system.

The initial detection processing performed by the object detection unit 106 may be the only detection processing performed thereby.

On the basis of joint position information estimated for the worker by the joint-position estimation unit 101, the object region entry/exit sensing unit 107 senses whether a joint position of the worker has entered and then exited the image region including the tool (object) detected by the object detection unit 106.

Specifically, for example, on the basis of the joint position information estimated by the joint-position estimation unit 101, the object region entry/exit sensing unit 107 senses the position of an image region (rectangle indicated by a broken line) including a joint position of the hand of the worker in the video data in FIG. 8. The object region entry/exit sensing unit 107 determines whether the location of the image region (rectangle indicated by a broken line) including the joint position of the hand of the worker has entered and then exited (i.e., covered and then moved away from) the location of the image region (rectangle indicated by a dashed dotted line) including the tool (object) detected by the object detection unit 106. In the case of FIG. 8, for example, since the image region (rectangle indicated by a broken line) of the joint position of the hand of the worker is separate from the location of the image region (rectangle indicated by a dashed dotted line) including the tool (object), the object region entry/exit sensing unit 107 determines that the joint position of the worker has not entered and then exited the image region of the tool (object). In situations such as those depicted in FIGS. 9 and 10, by contrast, the object region entry/exit sensing unit 107 determines that the image region (rectangle indicated by a broken line) of the joint position of the hand of the worker has entered and then exited the image region (rectangle indicated by a dashed dotted line) including the tool (object). In this case, the image extraction unit 103a extracts the image region (rectangle indicated by a dashed dotted line) of the object depicted in FIG. 10 from the video data, and the object recognition unit 104a recognizes the object (tool) within the range on the video data that has been extracted by the image extraction unit 103a.

If the object recognition unit 104a cannot recognize the tool (object) detected by the object detection unit 106, the object-detection activation unit 108 causes the object detection unit 106 to periodically detect the tool (object).

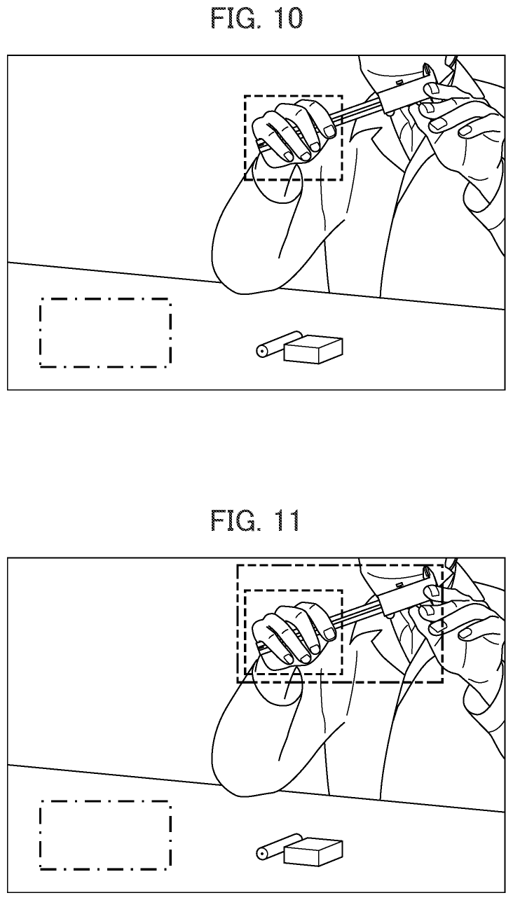

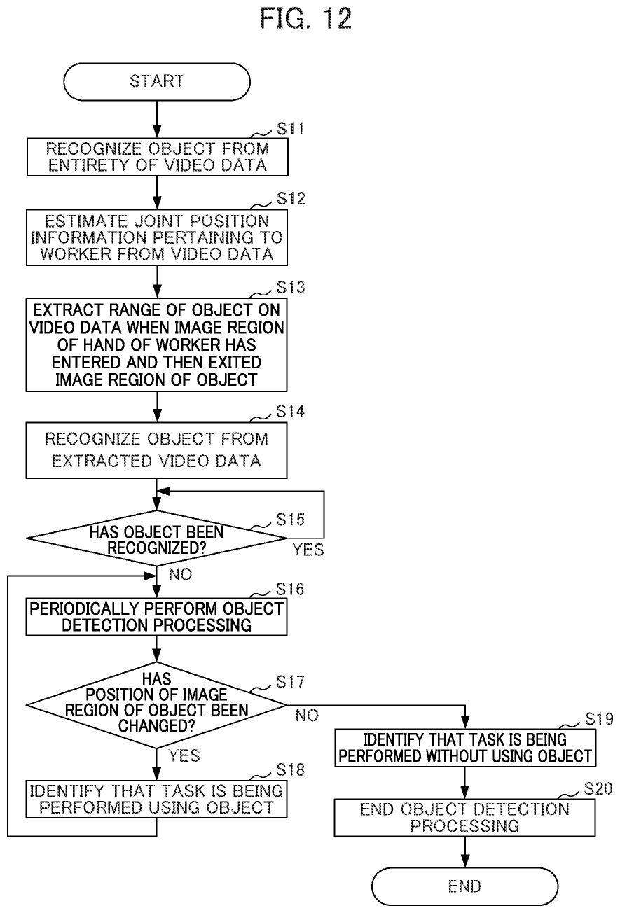

Specifically, for example, if the object recognition unit 104a cannot recognize the tool (object) detected by the object detection unit 106 within the image region in FIG. 10 indicated by a rectangle with a dashed dotted line, the object-detection activation unit 108 determines that the worker has started a task with the tool (object). Then, the object-detection activation unit 108 causes the object detection unit 106 to periodically (e.g., every second) detect the tool (object) from the entirety of the video data in FIG. 10. In this case, when the position of the image region (rectangle indicated by a two-dot chain line) of the detected tool (object) has changed as indicated in FIG. 11, the task estimation unit 1051a identifies that the worker is performing, by using the tool (object), the task identified by the task identification unit 105.

When the position of the image region (rectangle indicated by a two-dot chain line) of the tool (object) has not changed (or the tool (object) cannot be detected) and is separate from the image region (rectangle indicated by a broken line) of the hand of the worker with the image region (rectangle indicated by a broken line) of the hand of the worker moving, the task estimation unit 1051a identifies that the worker has ended using the tool (object). In this case, the object-detection activation unit 108 ends the periodic object detection by the object detection unit 106.

In view of the fact that the object detection processing is performed at a heavy load by the object detection unit 106, accordingly, the task analysis device 1A can decrease the number of times the object detection processing is performed by performing the same by means of object detection and joint position information only when the worker uses a tool (object).

Furthermore, the task analysis device 1A can determine whether the worker is using a tool (object) in the identified task of the worker.

### <Analysis Processing Performed by Task Analysis Device 1A>

Next, descriptions are given of operations pertaining to the analysis processing performed by the task analysis device 1A according to the second embodiment.

FIG. 12 is a flowchart illustrating the analysis processing performed by the task analysis device 1A. The indicated flow is performed repeatedly while video data is input from the camera 2.

In Step S11, the object detection unit 106 detects an object (tool) from the entirety of video data including the task of a worker.

In Step S12, the joint-position estimation unit 101 estimates joint position information pertaining to the hand of the worker from the video data.

In Step S13, when the object region entry/exit sensing unit 107 has determined that the image region of a joint position of the hand of the worker has entered and then exited an image region including the object (tool), the image extraction unit 103a extracts a range on the video data that pertains to the object (tool) detected in Step S11.

In Step S14, the object recognition unit 104a recognizes the object (tool) within the range on the video data that has been extracted in Step S13.

In Step S15, the object-detection activation unit 108 determines whether the object recognition unit 104a has recognized, in Step S14, the object (tool) detected in Step S11. If the object recognition unit 104a has recognized the detected object (tool), this means that the object (tool) is present at the original position (has not been used yet), so the process stays at Step S15. If the object recognition unit 104a has not recognized the detected object (tool), the process shifts to Step S16.

In Step S16, the object-detection activation unit 108 causes the object detection unit 106 to periodically perform detection processing for the object (tool).

In Step S17, the task estimation unit 1051a determines whether the position of the image region of the object (tool) detected in Step S16 has changed. If the position of the image region of the detected object (tool) has changed, the process shifts to Step S18. If the position of the image region of the detected object (tool) has not changed, the process shifts to Step S19.

In Step S18, the task estimation unit 1051a identifies that the worker is performing a task by using the tool (object).

In Step S19, when the image region of the object (tool) is separate from the image region of the hand of the worker and the image region of the hand of the worker is moving, the task estimation unit 1051a identifies that the worker is performing a task without using the object (tool).

In Step S20, the object-detection activation unit 108 causes the object detection unit 106 to end the detection processing for the object (tool). Meanwhile, the task analysis device 1A ends the analysis processing.

As described above, the task analysis device 1A according to the second embodiment detects an object from video data including the task of a worker, estimates joint position information pertaining to the worker from the video data, senses, on the basis of the estimated joint position information pertaining to the worker, whether an image region including a joint position of the worker has entered and then exited from an image region including the detected object, extracts, from the video data on the basis of the result of sensing, a range on the video data that pertains to the object detected from the video data, performs object recognition for the extracted range on the video data, and periodically detects the object when the object cannot be recognized within the range on the video data, so as to determine the task of the worker on the basis of a change in a coordinate of the object. Thus, the task analysis device 1A can recognize an object from an image so as to classify a task with a small computation amount.

The task analysis device 1A can also be implemented using an inexpensive device without the need for, for example, an expensive GPU.

The task analysis device 1A easily interprets the model of task classification, and the user can be convinced to use the same. For example, if there are problems with the accuracy in task classification, the problems can be divided into those whether the accuracy in object recognition is low and those whether the accuracy in detection of a characteristic joint position of a hand is low, so that the classification model can be easily extended and improved.

In view of the fact that the object detection processing is performed at a heavy load, the task analysis device 1A can decrease the number of times the object detection processing is performed by performing the same by means of object detection and joint position information only when the worker uses an object.

Furthermore, the task analysis device 1A can determine whether the worker is using an object in the identified task of the worker.

So far, descriptions have been given of the second embodiment.

Although the first and second embodiments have been described, the task analysis devices 1 and 1A are not limited to the above-described embodiments and include, for example, variations and improvements as long as objects can be attained.

### <First Variation>

In the first and second embodiments, the task analysis devices 1 and 1A are each connected to one camera 2. However, the present invention is not limited to this. For example, the task analysis devices 1 and 1A may each be connected to two or more, i.e., a plurality of, cameras 2.

### <Second Variation>

In the above-described embodiments, for example, the task analysis devices 1 and 1A have all the functions. However, the present invention is not limited to this. For example, a server may include some or all of the joint-position estimation unit 101, motion estimation unit 102, image extraction unit 103, object recognition unit 104, task identification unit 105, and task estimation unit 1051 of the task analysis device 1, or some or all of the joint-position estimation unit 101, motion estimation unit 102, image extraction unit 103a, object recognition unit 104a, task identification unit 105, task estimation unit 1051a, object detection unit 106, object region entry/exit sensing unit 107, and object-detection activation unit 108 of the task analysis device 1A. The functions of the task analysis devices 1 and 1A may be implemented using, for example, virtual server functions with a cloud technology.

Furthermore, the task analysis devices 1 and 1A may be a distributed processing system in which the functions of the task analysis devices 1 and 1A are distributed, as appropriate, over a plurality of servers.

The functions included in the task analysis devices 1 and 1A in the first and second embodiments may each be implemented by hardware, software, or a combination thereof. In this regard, the wording “implemented by software” means being implemented by a computer reading a program.

The program may be stored using various types of non-transitory computer readable media and supplied to the computer. The non-transitory computer readable media include various types of tangible storage media. Examples of the non-transitory computer readable media include, for example, magnetic recording media (e.g., flexible disk, magnetic tape, hard disk drive), magneto-optical recording media (e.g., magneto-optical disk), read only memories (CD-ROMs), CD-Rs, CD-R/Ws, and semiconductor memories (e.g., Mask ROM, programmable ROM (PROM), erasable PROM (EPROM), flash ROM, RAM). The program may be supplied to a computer by various types of transitory computer readable media. Examples of the transitory computer readable media include electric signals, optical signals, and electromagnetic waves. The transitory computer readable media can supply programs to a computer through wireless communication paths or wire communication paths such as electric wires and optical fibers.

Steps for describing programs recorded in the recording medium include processes that are performed in order in time series, and processes that are not necessarily performed in time series but performed in parallel or separately from each other.

Accordingly, the task analysis device of the present disclosure can implement various types and forms of embodiments having the following configuration.

(1) The task analysis device 1 of the present disclosure is a task analysis device for analyzing a task of a worker, the task analysis device including: a joint-position estimation unit 101 configured to estimate joint position information pertaining to the worker from video data including the task of the worker; a motion estimation unit 102 configured to estimate motion information pertaining to the worker on the basis of the joint position information estimated by the joint-position estimation unit 101; an image extraction unit 103 configured to extract, from the video data on the basis of the motion information estimated by the motion estimation unit 102, a range on the video data that pertains to an object associated with the motion information; an object recognition unit 104 configured to recognize the object within the range on the video data that has been extracted by the image extraction unit 103; and a task identification unit 105 configured to identify the task of the worker on the basis of the object recognized by the object recognition unit 104.

The task analysis device 1 can recognize an object from an image so as to classify a task with a small computation amount.

(2) In the task analysis device 1 described in section (1), when the motion estimation unit 102 estimates, on the basis of joint position information, motion information pertaining to the worker that includes a plurality of motions, the image extraction unit 103 extracts a plurality of ranges on video data for each of the plurality of estimated motions; the object recognition unit 104 recognizes an object for each of the plurality of ranges on the video data; and the task identification unit 105 may include a task estimation unit 1051 configured to estimate a task having the highest likelihood on the basis of the likelihood of each of the plurality of motions estimated by the motion estimation unit 102 and the likelihood of the object recognized for each of the plurality of ranges on the video data by the object recognition unit 104.

Accordingly, the task analysis device 1 can accurately identify the task of a worker even when the shape of the hand is ambiguous.

(3) The task analysis device 1 described in section (1) or (2) may further include: a motion storage unit 202 configured to store a rule base or a trained model for outputting motion information pertaining to the worker that corresponds to the joint position information estimated by the joint-position estimation unit 101; an object-positional-relationship storage unit 203 configured to store, in advance on the basis of motion information pertaining to the worker, a range on video data that includes an object associated with the motion information; and a task storage unit 204 configured to store a task table in which the object recognized by the object recognition unit 104 is mapped to the task of the worker in advance.

Accordingly, the task analysis device 1 easily interprets the model of task classification.

(4) The task analysis device 1A of the present disclosure is a task analysis device for analyzing a task of a worker, the task analysis device including: an object detection unit 106 configured to detect an object from video data including the task of the worker; a joint-position estimation unit 101 configured to estimate joint position information pertaining to the worker from the video data; an object region entry/exit sensing unit 107 configured to sense, on the basis of the joint position information estimated by the joint-position estimation unit 101, whether an image region including a joint position of the worker has entered and then exited from an image region including the object detected by the object detection unit 106; an image extraction unit 103a configured to extract, from the video data on the basis of the result of sensing by the object region entry/exit sensing unit 107, a range on the video data that pertains to the object detected by the object detection unit 106; an object recognition unit 104a configured to perform object recognition for the range on the video data that has been extracted by the image extraction unit 103a; an object-detection activation unit 108 configured to cause the object detection unit 106 to periodically detect the object in a case where the object recognition unit 104a is unable to recognize the object within the range on the video data; and a task estimation unit 1051a configured to identify the task on the basis of a change in a coordinate of the object detected in the video data by the object detection unit 106.

The task analysis device 1A can achieve effects similar to those achieved by the features described in section (1).

### EXPLANATION OF REFERENCE NUMERALS

1, 1A; Task analysis device
10, 10a: Control unit
101: Joint-position estimation unit
102: Motion estimation unit
103, 103a: Image extraction unit
104, 104a: Object recognition unit
105: Task identification unit 1
051, 1051a: Task estimation unit
106: Object detection unit
107: Object region entry/exit sensing unit
108: Object-detection activation unit
20, 20a: Storage unit
201: Video-data storage unit
202: Motion storage unit
203: Object-positional-relationship storage unit
204: Task storage unit
205: Object-coordinate storage unit
2: Camera
100: Task analysis system

1. A task analysis device for analyzing a task of a worker, the task analysis device comprising:
a joint-position estimation unit configured to estimate joint position information pertaining to the worker from video data including the task of the worker;
a motion estimation unit configured to estimate motion information pertaining to the worker on a basis of the joint position information estimated by the joint-position estimation unit;
an image extraction unit configured to extract, from the video data on a basis of the motion information estimated by the motion estimation unit, a range on the video data that pertains to an object associated with the motion information;
an object recognition unit configured to recognize the object within the range on the video data that has been extracted by the image extraction unit; and
a task identification unit configured to identify the task of the worker on a basis of the object recognized by the object recognition unit.

2. The task analysis device according to claim 1, wherein
in a case where the motion estimation unit estimates motion information pertaining to the worker that includes a plurality of motions on a basis of the joint position information, the image extraction unit extracts a plurality of ranges on the video data for each of the plurality of motions estimated,
the object recognition unit recognizes the object for each of the plurality of ranges on the video data, and
the task identification unit includes
a task estimation unit configured to estimate a task having a highest likelihood on a basis of a likelihood of each of the plurality of motions estimated by the motion estimation unit and a likelihood of the object recognized for each of the plurality of ranges on the video data by the object recognition unit.

3. The task analysis device according to claim 1, further comprising:
a motion storage unit configured to store a rule base or a trained model for outputting motion information pertaining to the worker that corresponds to the joint position information estimated by the joint-position estimation unit;
an object-positional-relationship storage unit configured to store, in advance on a basis of the motion information pertaining to the worker, a range on the video data that includes the object associated with the motion information; and
a task storage unit configured to store a task table in which the object recognized by the object recognition unit is mapped to the task of the worker in advance.

4. A task analysis device for analyzing a task of a worker, the task analysis device comprising:
an object detection unit configured to detect an object from video data including the task of the worker;
a joint-position estimation unit configured to estimate joint position information pertaining to the worker from the video data;
an object region entry/exit sensing unit configured to sense, on a basis of the joint position information estimated by the joint-position estimation unit, whether an image region including a joint position of the worker has entered and then exited from an image region including the object detected by the object detection unit;
an image extraction unit configured to extract, from the video data on a basis of a result of sensing by the object region entry/exit sensing unit, a range on the video data that pertains to the object detected by the object detection unit;
an object recognition unit configured to perform object recognition for the range on the video data that has been extracted by the image extraction unit;
an object-detection activation unit configured to cause the object detection unit to periodically detect the object in a case where the object recognition unit is unable to recognize the object within the range on the video data; and
a task estimation unit configured to identify the task on a basis of a change in a coordinate of the object detected in the video data by the object detection unit.
